(19) United States
(12) Patent Application Publication
(10) Pub. No.: US 2022/0044124 A1
(43) Pub. Date: Feb. 10, 2022

(54) Convolutional Self-encoding Fault Monitoring Method Based on Batch Imaging

(71) Applicant: BEIJING UNIVERSITY OF TECHNOLOGY, Beijing (CN)

(72) Inventors: Pu WANG, Beijing (CN); Haili ZHANG, Beijing (CN); Xuejin GAO, Beijing (CN); Huihui GAO, Beijing (CN)

(21) Appl. No.: 17/506,619

(22) Filed: Oct. 20, 2021

Related U.S. Application Data
(63) Continuation of application No. PCT/CN20/96733, filed on Jun. 18, 2020.

(30) Foreign Application Priority Data
Nov. 6, 2019 (CN) 201911073980.7

(51) Int. Cl. G06N 3/08; G06F 11/00

(52) U.S. Cl. CPC G06N 3/084; G06F 11/008

(57) ABSTRACT

The invention discloses a convolution self-encoding fault monitoring method based on batch imaging, and belongs to the technical field of batch process fault monitoring. The method comprises two steps of off-line modeling and on-line monitoring. The offline modeling step comprises the following steps: firstly, normalizing three-dimensional data of intermittent process; then, taking the two-dimensional array of each batch as an image to be directly input into a convolutional auto-encoder (CAE) to carry out deep unsupervised feature learning; and finally, constructing statistics and corresponding control limits for the features learned by CAE by utilizing a support vector machine. The online monitoring step includes: normalizing the collected data, and carrying out batch filling; inputting the normalized and filled batch graph into trained CAE to learn features; and calculating an online statistic, comparing online statistic with an offline control limit. Compared with the prior art, the technical scheme provided by the invention avoids information loss caused by data expansion, does not need to divide stages to reduce modeling workload, deeply extracts change characteristics of process variables, and reduces false alarm and missing report rate of intermittent process monitoring.

### CROSS-REFERENCE TO RELATED APPLICATIONS

This application is a continuation of International Application No. PCT/CN2020/096733, filed on Jun. 18, 2020, which claims priority to Chinese Patent Application No. 201911073980.7, filed on Nov. 6, 2019. The contents of the above applications are hereby incorporated by reference in their entireties and form a part of this specification.

### TECHNICAL FIELD

The invention belongs to the technical field of fault monitoring, relates to an intermittent process on-line fault monitoring technology based on data driving, and particularly relates to a convolution self-coding fault monitoring method based on batch imaging.

### BACKGROUND ART

At present, the intermittent production process is becoming more refined and intensive. Effective monitoring of entire production process is essential, because this can not only ensure production safety of intermittent process, but also improve product quality and production efficiency, and reduce enterprise energy consumption and Pollution.

The most commonly used method in the research of intermittent process fault monitoring is a multi-dimensional statistical method with multiway principal component analysis (MPCA) and multiway partial least squares (multiway partial least squares, MPLS) as the core, through the construction of T² (Hotelling-T²) and SPE (square prediction error) statistics, and compare them with the statistical control limits obtained by historical data modeling under normal conditions to achieve fault monitoring. T² statistics reflect each principal component deviates from model in the trend and amplitude, it is a measure of the internalization of the model. It can be used to monitor multiple principal components at the same time; SPE statistics describe the measured value of input variable versus the principal component, it is a measure of the external changes of the model. For the typical three-dimensional array form of the intermittent process, multivariate statistical method cannot directly model the three-dimensional data. Commonly used data preprocessing method is to expand the three-dimensional data into a two-dimensional matrix along the variable or batch direction, and then perform data analysis and modeling, etc. However, two-dimensional expansion of three-dimensional data will lose some information. In view of multi-stage nature of the batch process, the batch process is usually divided into different stages first, and then the fault monitoring is performed by modeling in each stage. Gao Xuej in et al. proposed to add time variables to the nuclear entropy load matrix in the document “Fault Monitoring of Fermentation Process Based on Extended Nuclear Entropy Load Matrix” and use fuzzy C-means to divide the batch process into stages. However, how to reasonably divide by stages is a difficult problem for this type of method, and the phased modeling is to model the data of each stage independently, without considering the correlation of the data between different stages, that is, without considering the global feature information of the entire batch, and there is no unified standard for stage division, the modeling steps are cumbersome, and it is difficult to update.

Convolutional autoencoder (CAE) is an unsupervised learning method that reverses operations such as convolution and pooling in a convolutional neural network, reconstructs the input data, feature learning is realized by minimized input data and the mean square error of reconstructed data, it has the advantages of convolutional neural network (CNN) for local feature extraction without data labeling. This method was initially applied to image recognition, and in recent years it has been gradually expanded to be applied to abnormal detection of images, videos, wafers, etc., but it is rarely used in fault monitoring of intermittent processes.

### SUMMARY

In order to make up for the above-mentioned shortcomings of the prior art, the present invention provides a convolutional self-encoding fault monitoring method based on batch imaging. Regarding each batch of data as a two-dimensional grayscale image, there is no need to perform two-dimensional conversion of three-dimensional array in intermittent process which avoiding information loss; the data change in each batch can be seen as texture change of the picture, and the overall modeling is sufficient considering the dynamic changes in correlation of variables, it greatly reduces the amount of calculation compared with staged modeling; the two-dimensional gray map is directly input into CAE to extract the characteristics of intermittent process, and the model is built without fault data and labels; an one-class support vector (OCSVM) method constructs the monitoring statistics of the proposed features and determines its control limits, and realizes fault monitoring by comparing the monitoring statistics at the current sampling time with control limits.

The invention images the batch data in multi-stage, non-linear and three-dimensional data form of intermittent process, establish a convolutional autoencoder model and use OCSVM for fault monitoring to improve the accuracy and monitoring performance of the model; the following technical solutions and implementation steps are given:

Image processing the batch data, establish a convolutional autoencoder (CAE) model and use a type of support vector machine method (OCSVM) for fault monitoring, the specific steps are as follows:

### A. Offline Modeling Stage

1) Collection of historical data: intermittent production cyclically reciprocates according to a certain cycle, and batch products are obtained in batches after the end of a single cycle; the data of K process variables at J times are collected in each batch to obtain a two-dimensional matrix X(K×J), where K is the number of process variables collected, J is the number of sampling points, and 1 batches constitute a typical three-dimensional data representation form of the batch process-X(I×K×J);

2) Data normalization: maximum and minimum normalized data processing methods are used to eliminate the influence of dimensions between different process variables, and the actual data range of the process variables is converted into the data range of the gray image that meets the computer processing, that is, between 0 and 1, the calculation formula is as follows:

$$\tilde{x} = \frac{x - {x}_{min}}{{x}_{max} - {x}_{min}} \qquad ( 1 )$$

The specific steps are:
a) Expand historical three-dimensional data X (I×K×J) into two-dimensional data X (IK×J) along the variable direction;
b) Find the maximum and minimum values of each variable;
c) Normalize each variable;
d) Refold the two-dimensional array into a three-dimensional array;
e) Calculate the average of all training batches to obtain the average value of normal batch data at each time;

3) Set CAE network parameters and input the data into CAE for training; in CAE, several convolutional layers, pooling layers, and fully connected layers constitute the coding unit, fully connected layer, de-pooling layer and deconvolution layer constitutes the decoding unit; loss function adopts the mean square error function, by minimizing the loss function, reconstructing the mean square error between data and input data, and using back propagation algorithm to adjust the weight of each layer to realize unsupervised learning of features;

4) Design statistics and control limits: Introduce OCSVM to model features extracted by CAE, find the optimal solution of hyperplane, and obtain the statistical calculation formula; design the monitoring statistics as t opposite of the distance to the hyperplane, denoted by D, which is shown in formula (2):

D=−(w*·ϕ(x)+b*) (2)

0 is the control limit of the designed statistics. When D>0, a fault occurs, otherwise it is normal;

### B. Online Monitoring Stage

1) Data collection: Collect the data of all variables at the current moment k to get X_{new,k}(1×J);

2) Data normalization: normalize according to the maximum and minimum values of each variable obtained offline;

3) Batch filling: Combine the normalized data at time k and time 1˜k−1, and fill in the data at time k+1˜K that does not occur subsequently with average value of the corresponding time of normal batch obtained in offline phase;

4) Feature extraction: a batch of filled data is input to the offline modeling and training network to extract features;

5) Fault monitoring: Substituting features extracted in the previous step into formula (2), and calculating the statistic D, if D>0, it is determined that there is a fault at the current moment, and corresponding measures are taken, otherwise it is a normal state and needs to continue to monitor production process until the end of batch.

### BENEFICIAL EFFECT

The invention uses each batch of process data as a two-dimensional grayscale image, directly inputs it into the convolution autoencoder for unsupervised learning, and uses OCSVM to design statistics for the extracted features and determine the control limit to realize fault monitoring. It avoids the loss of information caused by data expansion, there is no need to divide the stages to reduce the modeling workload, and the change characteristics of process variables are deeply extracted.

The method of the invention can reduce the occurrence of false alarms and omissions in process monitoring, and improve the accuracy of fault monitoring.

### DESCRIPTIONS OF THE DRAWINGS

FIG. 1 includes FIGS. 1(a)-1(e) and shows the monitoring results of the CAE-OCSVM method, multi-stage MPCA and MPCA of the present invention on the failure batch 1. FIGS. 1(a)-1(e) of FIG. 1 are monitoring curve of SPECAE-OCSVM, multi-stage MPCA-T², multi-stage MPCA-SPE, MPCA-T², and MPCA-SPE of fault batch 1, respectively;

FIG. 2 includes FIGS. 2(a)-2(e) and shows the monitoring results of the CAE-OCSVM method, multi-stage MPCA and MPCA of the present invention on the failure batch 1. FIGS. 2(a)-2(e) are monitoring curve of SPECAE-OCSVM, multi-stage MPCA-T², multi-stage MPCA-SPE, MPCA-T², and MPCA-SPE of fault batch 2, respectively.

### PREFERRED EMBODIMENT

Pensim penicillin fermentation simulation platform is a standard platform for evaluating the effectiveness of intermittent process fault monitoring developed by Professor Cinar of Illinois Institute of Technology and others.

In this experiment, a total of 10 process variables were collected. The variable names are shown in Table 1. The sampling interval is 1 h. 50 normal batches are selected as training samples, and 2 faulty batches are used as test samples.

Among them, the fault batch 1 is a step change with an amplitude of 1 in the ventilation rate at 200 h, and the fault batch 2 is a ramp change with a slope of 0.003 in the stirring power at 200 h.

TABLE 1
Variables used to build the model

| Variable | |
|---|---|
| code | Variable name |
| X1 | rate of venting (L/h) |
| X2 | power of agitator (W) |
| X3 | Bottom logistics acceleration |
| | rate |
| | (L/h) |
| X4 | loading temperature (K) |
| X5 | concentration of dissolved |
| | oxygen mole/L |
| X6 | Exhaust CARBON |
| | dioxide |
| | concentration |
| | (mole/L) |
| X7 | PH |
| X8 | Temperature (K) |
| X9 | Healt of reaction |
| | (cal) |
| X10 | Acceleration rate of |
| | cold water flow |
| | (L/h) |

Based on the above content, the present invention is applied to the above fermentation process simulation platform, and the specific implementation steps are as follows:

### A. Offline Modeling Stage

1): Collection of historical data

2): Normalize the historical data, use the maximum and minimum normalized data processing method to eliminate the influence of dimensions between different process variables, and convert the actual data range of the process variable into the data range of the gray image that meets the computer processing, which is a number between 0 and 1; the calculation formula is as follows:

$$\tilde{x} = \frac{x - {x}_{min}}{{x}_{max} - {x}_{min}} \qquad ( 1 )$$

The specific steps are:
a) Expand historical three-dimensional data X (I×K×J) into two-dimensional data X (IK×J) along the variable direction;
b) Calculate the maximum and minimum values of each variable;
c) Normalize each variable;
d) Refold the two-dimensional array into a three-dimensional array;
e) Calculate the average of all training batches to obtain the average value of the normal batch data at each time;

3): Input the normalized three-dimensional data into the convolutional autoencoder for unsupervised learning of features. The structural parameters of the CAE model designed by the present invention are shown in Table 2, which includes two convolutional layers, one pooling layer, two fully connected layers, one de-pooling layer and two deconvolutional layers. Among them, conv(1,16,(11,5),(2,1),(5,2)) means that the number of input channels of the convolutional layer is 1, the number of output channels is 16, and the size of the convolution kernel is 11*5, the step size is 2*1, the padding size is 5*2; maxpool(2,2) refers to the maximum pooling layer core size is 2*2, the step size is 2; linear(10) refers to the number of nodes in the output feature layer Is 10. The network structure parameters of the encoding stage and the decoding stage are same, and the corresponding feature dimensions of each layer are also basically the same. Each convolutional layer and the deconvolution layer after the first deconvolution layer uses the tanh activation function, and the activation function after the second deconvolution layer uses the sigmoid function, which is to scale the network output to 0-1 Within the range for comparison with network input. In case that the number of variables and sampling points in fermentation process cannot be divisible by the size of convolution kernel or pooling kernel, resulting in different feature dimensions between encoding and decoding stage, the present invention adds output padding parameter to the deconvolution layer to integrate data dimension. Make reconstructed data equal to the dimension of input data. In network training parameters, the learning rate is set to 0.0001, batch_size is set to 10, and epoch is set to 10.

TABLE 2
CAE network structure parameters

| No. | Name | Parameter |
|---|---|---|
| 1 | Convolutional | Conv(1,16,(11,5),(2,1),(5,2)) |
| | Layer 1 | |
| 2 | Convolutional | Conv(16,32,(11,5),(2,1),(5,2)) |
| | Layer 2 | |
| 3 | Pooling Layer | MaxPool(2,2) |
| 4 | fully connected | Linear(10) |
| | layer | |
| 5 | fully connected | Linear(10) |
| | layer | |
| 6 | depooling layer | MaxUnpool(2,2) |
| 7 | Deconvolution | ConvTranspose(1,16,(11,5), |
| | layer 2 | (2,1),(5,2)) |
| 8 | Deconvolution | ConvTranspose(16,32,(11,5), |
| | layer 1 | (2,1),(5,2)) |

4): Use OCSVM to learn the distribution of CAE extraction features, find the optimal solution of the hyperplane, and obtain the statistical calculation formula, design the monitoring statistics as opposite of the distance to the hyperplane, denoted by D which is shown in formula (2):

D=−(w*·ϕ(x)+b*) (2)

### B. Online Monitoring Stage

1): Select the kth moment of the fault data for fault monitoring;

2): Normalize all data from 1 to k;

3): The data at time k+1˜400 that did not occur subsequently are filled with the average value of the corresponding time of normal batch.

4): Input a whole batch of filled data into network trained in offline modeling stage to extract features;

5): Substitute the features extracted in the previous step into the statistical calculation formula (2), calculate the statistical D, if D>0, determine that there is a fault at the current moment, and take corresponding measures, otherwise it is normal and needs to continue monitoring the production process until the end of batch.

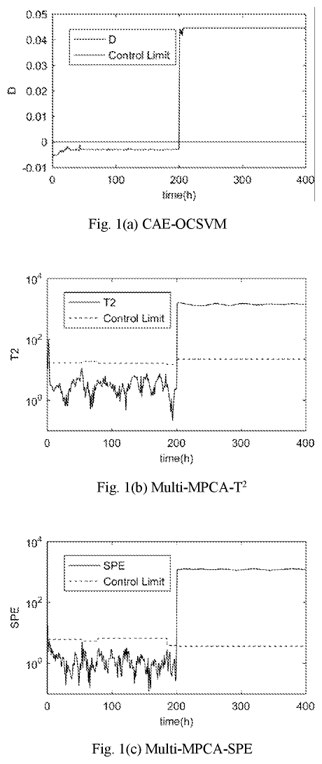

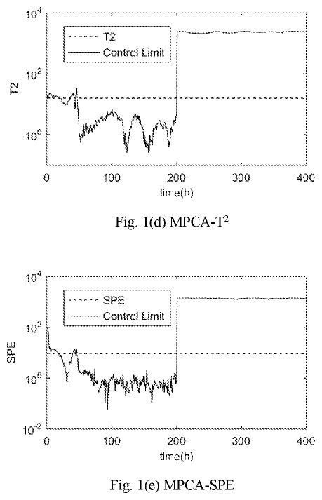

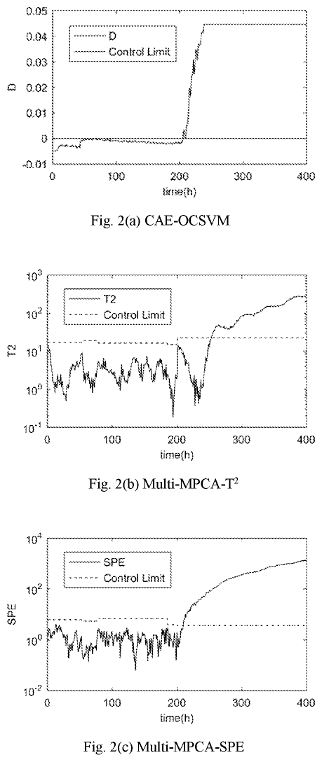

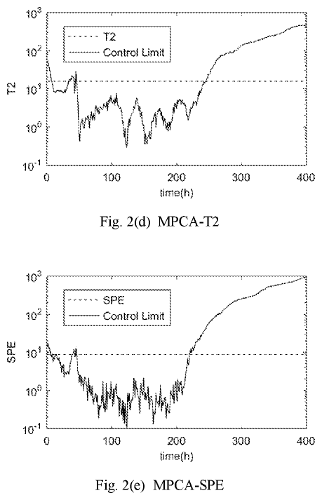

In order to verify the accuracy and effectiveness of the proposed method for fault monitoring, experiments were carried out on the step and slope fault data respectively, and compared with the MPCA and multi-stage MPCA methods. Among them, the MPCA algorithm first expands three-dimensional data into two dimensions according to the variables, and then performs PCA dimensionality reduction, and selects the principal components at a variance contribution rate of 85%. The multi-stage MPCA directly uses the results of Gao Xuejin et al.'s “fermentation process fault monitoring based on the extended nuclear entropy load matrix” and divides the penicillin fermentation process into five stages, three stable stages namely (1˜53)h, (79˜185)h, (206˜400)h and two transition stages (54˜78)h, (186˜205)h, each stage uses MPCA to separately model and monitor faults. The experimental results are shown in FIG. 1 and FIG. 2.

FIGS. 1 and 2 show the monitoring results of failed batches 1 and 2 by three methods of MPCA, multi-stage MPCA and CAE, respectively. It can be seen from the monitoring diagram that the CAE method can detect fault 1 and fault 2 without false alarms. Only 6% of the faulty batches have missed alarms; although the multi-stage MPCA method can also detect faults 1 and 2 Fault 2, but there is a false alarm in the early fermentation of fault batch 1, and the detection time on fault 2 is late, and the missed alarm rate is high; MPCA has false alarm in the early stage of production (1-5 h) of faulty batches 1 and 2, during stage changing of these two faulty batches (False alarms occurred at 45 h), and the missed alarm rate of fault 2 is higher.

MPCA method does not consider the stage change, so a false alarm occurs near the stage change. Both the multi-stage MPCA and MPCA methods have false alarms in the early stages of production. This is because the initial conditions of different batches of penicillin fermentation will be different. Both methods are more sensitive to this, while CAE method images the batch data. It is more robust to grasp the overall change characteristics of each batch while extracting local features. At the same time, the OCSVM method describes the distribution characteristics of normal batch features, avoiding inability of CAE features to construct T² defects in statistics. In general, compared with MPCA and multi-stage MPCA, the monitoring effect of this method is better.

What is claimed is:

1. A convolutional self-encoding fault monitoring method based on batch imaging comprising: image processing batch data, establishing a convolutional autoencoder (CAE) model and using a support vector machine method (OCSVM) for fault monitoring, the specific steps are as follows:
A; offline modeling stage:
1) collection of historical data: intermittent production cyclically reciprocates according to a certain cycle, and batch products are obtained in batches after the end of a single cycle; data of K process variables at J times are collected in each batch to obtain a two-dimensional matrix X(K×J), where K is the number of process variables collected, J is the number of sampling points, and I batches constitute a typical three-dimensional data representation form of a batch process-X(I×K×J);
2) data normalization: maximum and minimum normalized data processing methods are used to eliminate the influence of dimensions between different process variables, and an actual data range of the process variables is converted into a data range of a gray image that meets computer processing between 0 and 1, a calculation formula is as follows:
$$\tilde{x} = \frac{x - {x}_{min}}{{x}_{max} - {x}_{min}} \qquad ( 1 )$$
the specific steps are:
a) expand historical three-dimensional data X (I×K×J) into two-dimensional data X (IK×J) along a variable direction;
b) calculate maximum and minimum values of each variable;
c) normalize each variable;
d) refold a two-dimensional array into a three-dimensional array;
e) calculate an average of all training batches to obtain an average value of normal batch data at each time;
3) set CAE network parameters and input data into CAE for training; in CAE, several convolutional layers, pooling layers, and fully connected layers constitute a coding unit, fully connected layer, de-pooling layer and deconvolution layer constitute a decoding unit; loss function adopts a mean square error function, by minimizing the loss function, reconstructing the mean square error between data and input data, and using back propagation algorithm to adjust a weight of each layer to realize unsupervised learning of features;
4) design statistics and control limits: Introduce OCSVM to model features extracted by CAE, find an optimal solution of hyperplane, and obtain a statistical calculation formula; design monitoring statistics as t opposite of a distance to the hyperplane, denoted by D, which is shown in formula (2):
D=−(w*·ϕ(x)+b*) (2)
0 is a control limit of the designed monitoring statistics; when D>0, a fault occurs, otherwise it is normal;
B; online monitoring stage:
1) data collection: collect data of all variables at a current moment k to get X_{new,k}(1×J);
2) data normalization: normalize according to the maximum and minimum values of each variable obtained offline;
3) batch filling: combine the normalized data at time k and time 1−k−1, and fill in data at time k+1−K that does not occur subsequently with average value of a corresponding time of normal batch obtained in offline phase;
4) feature extraction: a batch of filled data is input to an offline modeling and training network to extract features;
5) fault monitoring: substituting features extracted in previous step into formula (2), and calculating statistic D, if D>0, it is determined that there is a fault at the current moment, and corresponding measures are taken, otherwise it is a normal state and needs to continue to monitor production process until the end of batch.
